(19) United States
(12) Patent Application Publication
(10) Pub. No.: US 2010/0326301 A1
(43) Pub. Date: Dec. 30, 2010

(54) Variable Ink Metering and Delivery System for Flexographic Printing

(76) Inventor: Ralph E. Dedman, Coon Rapids, MN (US)

Correspondence Address: GEORGE A LEONE, SR;CITADEL PATENT LAW, 9124 Gravelly Lake Drive SW, SUITE 102, Lakewood, WA, 98499, US

(21) Appl. No.: 12/492,897

(22) Filed: Jun. 26, 2009

(51) Int. Cl. B41F 31/00

(52) U.S. Cl. 101/350.1; 101/485

(57) ABSTRACT

A method for flexographic printing includes applying a control value to an ink pumping and control system responsive to the control value, where the control value sets an operating mode of the ink pumping and control system. Ink is pumped according to the set operating mode through a rotary coupling into a rotating diffusion cylinder, where the diffusion cylinder has an inner channel, an outer surface and a plurality of passages. Ink is first metered through the plurality of passages so as to contact a permeable membrane covering the diffusion cylinder and secondarily metered by passing through the permeable membrane onto a printing plate or printing sleeve which is impressed onto a printing medium to produce a printed output, where the printed output is sensed to provide a modified control value that is then applied to the ink pumping system.

### TECHNICAL FIELD

The present invention relates to flexographic printing in general, and, more particularly, to a variable ink metering and delivery flexographic printing system, in which a diffusion mechanism is metered to allow controlled delivery of ink to a printed output, such as a flexographic printing plate or printing sleeve.

### BACKGROUND

The flexographic printing process is heavily used by the food packaging industry for their package printing needs. Flexography, which evolved from the letter press, uses a flexible relief printing plate or printing sleeve along with an anilox roll in its printing process. The image of what is to be printed is etched into the printing plate or printing sleeve by a computer-guided laser, a molding process or through using a light-sensitive polymer. The printing plates or sleeves are typically either rubber or polymer. The flexographic printing process currently utilizes an ink metering and delivery system which consists of an ink reservoir, an anilox roll, and a “wiping” system (typically a doctor blade or a metering roll) to control excess ink delivery. In order to print an image, ink is transferred from an ink roll or reservoir to the anilox roll and from the anilox roll onto a printing plate or printing sleeve which then reproduces the image.

A flexographic printing sleeve (herein called “printing sleeve”) can be used as a carrier roll for flat, imaged printing plates mounted on the surface. One example of a carrier roll sleeve is disclosed in U.S. Pat. No. 6,619,200, to Cacchi, issued Sep. 16, 2003 and entitled “METHOD FOR PRODUCING FLEXOGRAPHIC PRINTING SLEEVES, AND THE SLEEVE OBTAINED,” which is incorporated by reference. In other applications, an image for printing is directly engraved on the flexographic printing sleeve surface, eliminating the need for a flexographic printing plate. In some examples, printing sleeves are made from a continuous pre-manufactured sleeve with a seamless layer of photopolymer topped by a laser ablation mask coating, ready for imaging, exposure, and processing. Other types of printing sleeves are also available, made, for example, by mounting individual pieces of photopolymer on a base sleeve with sticky-back tape.

Referring now to FIG. 1, an example of a flexographic printing setup as used in the prior art is shown. The setup may include a metering doctor blade 50 which bears on an anilox roll 52. The anilox roll 52 rotates while metering ink onto an oppositely rotating printing plate cylinder 54. The printing plate cylinder 54 impresses a printed output onto a substrate or web 58. An impression cylinder 56 provides resistance for the printing plate cylinder 54. In some applications, as indicated here, the metering doctor blade may be enclosed in a blade assembly and include input and output ports for metering ink.

Anilox rolls are hard cylinders with steel or aluminum cores which are coated with an industrial ceramic and laser-engraved with many small dimples or cells. The number and density of cells on a given roll varies according to the amount of resolution and detail required. An engraved anilox roll is expensive, delicate and susceptible to damage by mishandling. Care must be taken not to scratch or bump the roll or otherwise degrade the cells, as when wiping with a doctor blade. Unfortunately, while currently ubiquitous in flexography, doctor blades present substantial hazards. As currently used the blades are dangerously sharp, thus adversely affecting workplace safety. Further, doctor blades themselves can be a cause of damage to the delicate cell structures engraved on anilox rolls. Therefore, there is an unanswered need in the art to eliminate wiping with doctor blades, while maintaining an acceptable level of printing quality.

Besides the hazards associated with doctor blades and the use of expensive anilox rolls, flexographic printing systems exhibit a number of additional drawbacks. For example, there is a need for an improved system that adjusts the supply of the applied ink film during operation without stopping the process to replace or adjust major components. There is also a need for more consistent, and repeatable ink delivery that overcomes problem factors that affect anilox rolls like surface wear, cell plugging, damage during use and handling, and difficulty in cleaning. Further, the process of producing the ceramic anilox roll is inconsistent and difficult to control, making the production of similar rolls with the same ink delivery characteristics virtually impossible.

These factors, along with other variables, prevent the flexographic printing process from producing a level of predictable, repeatable print quality which is competitive with other common print processes (e.g. offset/litho, gravure, and digital). Additionally, since key components are prone to frequent wear, damage, and loss of available volume, the cost to clean, repair, or replace these components detrimentally impacts efficient, cost-effective print production. The present invention as disclosed herein provides new and novel solutions to the aforesaid problems by providing a system that eliminates both the need for anilox rolls and doctor blades.

### BRIEF SUMMARY OF THE DISCLOSURE

A system and method for flexographic printing is disclosed including apparatus and methods for:

(a) applying a control value to an ink pumping and control system responsive to the control value, where the control value sets an operating mode of the ink pumping and control system;

(b) pumping ink according to the set operating mode through a rotary coupling into a rotating diffusion cylinder, where the diffusion cylinder has an inner channel, an outer surface and a plurality of passages surrounding the inner channel, wherein each of the plurality of passages runs though the diffusion cylinder from the inner channel to the outer surface;

(c) first metering ink through the plurality of passages so as to contact a permeable membrane covering the diffusion cylinder;

(d) secondly metering ink passing through the permeable membrane onto a printing plate or printing sleeve;

(e) impressing the printing plate or printing sleeve onto a printing medium to produce a printed output;

(f) sensing the printed output to provide a modified control value;

(g) applying the modified control value to the ink pumping system; and

(h) repeating steps (b)-(g).

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows a block diagram of one example of a known flexographic printing system.

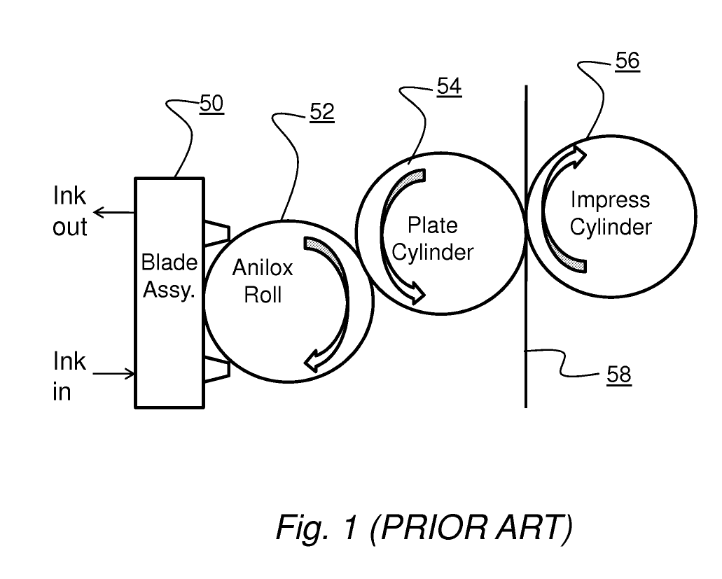

FIG. 2 schematically shows a block diagram of one example of a flexographic printing system employing two-stage ink metering.

FIG. 3 schematically shows a more detailed example of a diffusion cylinder as employed in a flexographic printing system employing two-stage ink metering.

FIG. 4 schematically shows an exploded view of a diffusion cylinder with a permeable membrane sleeve as employed in a flexographic printing system in accordance with the disclosure herein.

FIG. 5 schematically shows a more detailed example of a pumping and control system as employed in a flexographic printing system in accordance with the disclosure herein.

FIG. 6 schematically shows a flow diagram of a flexographic printing system employing two-stage ink metering.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments and systems for flexographic printing processes. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to different control arrangements. However, it will be understood that these examples are for the purpose of illustrating the principles, and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

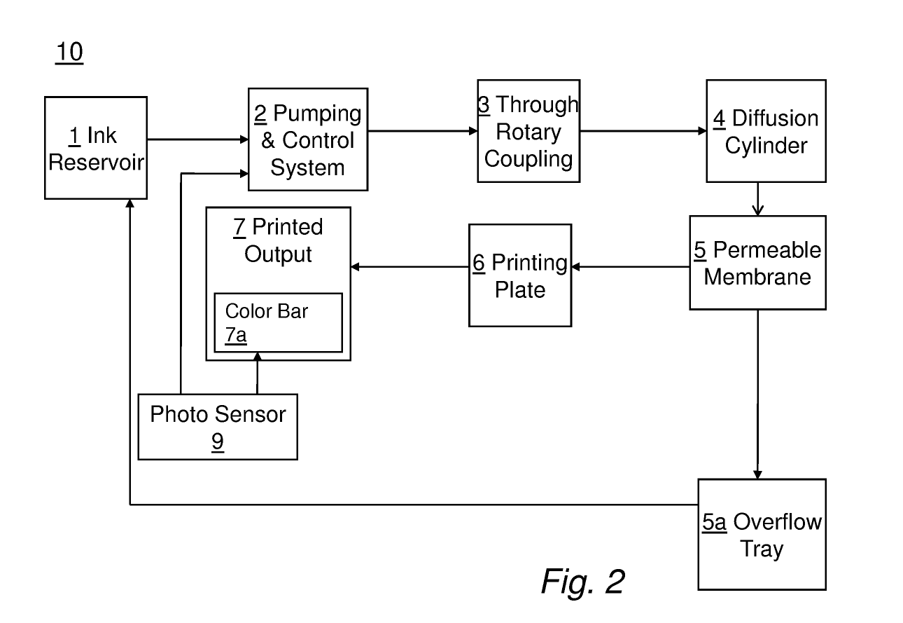

Referring now to FIG. 2, a block diagram of one example of a flexographic printing system is schematically shown. A flexographic printing system 10 includes an ink reservoir 1 coupled to a pumping and control system 2 which is, in turn, coupled to through rotary coupling 3, which is, in turn, coupled to diffusion cylinder 4. The diffusion cylinder 4 is covered by permeable membrane 5 to form a diffusion cylinder/sleeve assembly. Ink passes through the printing surface of permeable membrane 5 to a printed output. Excess ink from the permeable membrane 5 may advantageously be captured by an overflow tray 5a. The overflow collection tray 5a is typically mounted underneath the diffusion cylinder/sleeve assembly. The overflow collection tray 5a may be equipped with wiping surfaces along the edges and the rear lip, in order to wipe away any unapplied ink from the surface as the cylinder turns. The overflow tray 5a may also advantageously be coupled to the ink reservoir 1 for the purpose of reticulating unused ink. For example, a drain hose may be attached between the overflow collection tray 5a and the ink reservoir 1 to return excess ink to the ink reservoir by gravity feed.

The printed output 7 may advantageously include quality control indicia 7a such as a color bar or equivalent printed pattern on the printed output. A photo sensor 9 may be advantageously located to sense the color bar properties as a control mechanism.

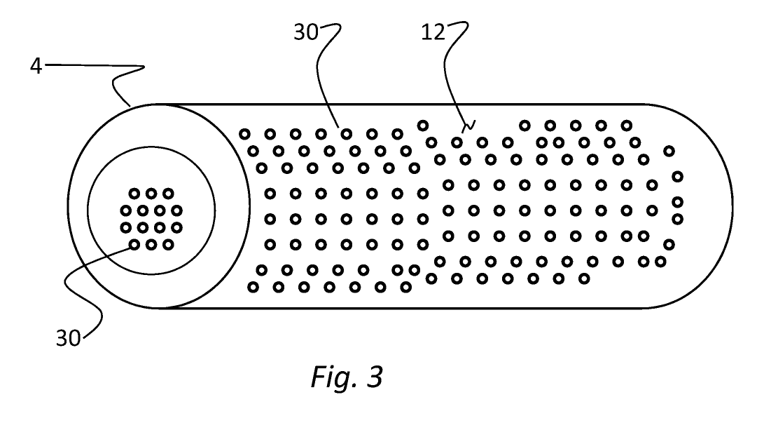

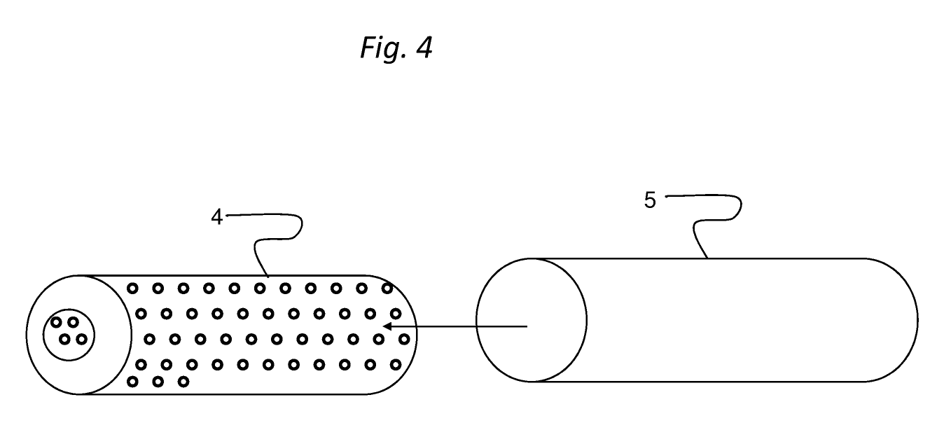

In one example embodiment the ink pumping and control system 2 is responsive to a control value, where the control value sets an operating mode of the ink pumping and control system to variably pump ink to a pump output. The ink reservoir 1 is coupled to an input port of ink pumping and control system 2. A rotary coupling is coupled at a rotary input to the pump output and further includes an output port coupled to the diffusion cylinder 4, which, in turn, is coupled to receive ink pumped through the rotary coupling 3 while rotating. The diffusion cylinder 4 has an inner channel, an outer surface and a plurality of passages surrounding the inner channel, wherein each of the plurality of passages runs though the diffusion cylinder from the inner channel to the outer surface for metering ink at a coarse rate through the plurality of passages as described further herein below with respect to FIG. 3. A permeable membrane 5 is snugly fit over the diffusion cylinder 4 to cover the plurality of passages to receive the coarsely metered ink and, in turn, finely metering ink passing through the permeable membrane as described further herein below with respect to FIG. 4. The printing plate 6 contacts the permeable membrane so as to receive the finely metered ink. A printing medium (bearing against a not-shown substrate or impression cylinder) is in rotary contact with the printing plate to produce a printed output 7. A photo sensor 9 is disposed to sense a portion of the printed output to provide a modified control value.

It will be understood that the apparatus and method described herein applies to both printing plates and printing sleeves. Thus examples and terminology referring to “printing plates” or “plates” are equally applicable to “printing sleeves” and equivalents.

In another example, the flexographic printing system 10 allows for instant control of the amount of ink delivered to the next step of the print process, by using a pressurized ink supply, delivered through a porous diffusing cylinder, and further metered through a permeable application membrane. An operator can control the pressure of the ink supply. Using the sensor, processor and pump controls, the operator can monitor, adjust, and recreate the desired ink volume within the press run, in subsequent press runs, and even across multiple press equipment which are similarly equipped. The design of the flexographic printing system 10 substantially eliminates factors of wear, damage and cleaning difficulty, which prevents variability of print quality.

Referring now to FIG. 3, an example of a diffusion cylinder is schematically shown. The diffusion cylinder 4 includes an inner channel 10 and a machined outer surface 12. In operation, the diffusion cylinder 4 acts as the initial stage of the metering and distribution of the pressurized ink. Ink is forced from the inner channel 10 through machined (e.g. drilled) passages to the machined outer surface 12. The cylinder can be constructed from a variety of materials, including metal, aluminum, steel, plastic, polymers, nylon and equivalents using conventional roll fabrication techniques.

Referring now to FIG. 4, an example of a diffusion cylinder with a permeable membrane sleeve as employed in a flexographic printing system in accordance with the disclosure herein is schematically shown. The permeable membrane 5 may advantageously be a sleeve that is snugly fitted over the diffusion cylinder 4 in order to further meter and spread the ink evenly when applied to a printing plate or printing sleeve. The membrane 5 acts as a second stage of the metering and distribution of the pressurized ink, by allowing the ink from the diffusion cylinder surface to pass through the membrane's porous plastic construction. The permeable membrane 5 may comprise a selectively permeable or semi-permeable membrane that allows printing ink to pass through the membrane. The permeable membrane may be a multilayer composite comprising polymers, fine mesh screens, combinations of materials resistant to ink corrosion and the like. The permeability of the membrane can be adjusted during manufacture in order to impart specific permeability for various types of printing ink (for example, solvent-, water-, and UV-based chemistries), their relative viscosity and rheology characteristics, and the desired ink film to be delivered to the printing plate or printing sleeve. Although ink-permeable membranes have been used in printing modules, until now it is believed that no one has incorporated an ink-permeable membrane in a flexographic printing system. One example of a printing module incorporating an ink-permeable membrane is disclosed in U.S. Pat. No. 5,555,007, issued Sep. 10, 1996 to Ceschin et al. which is incorporated by reference.

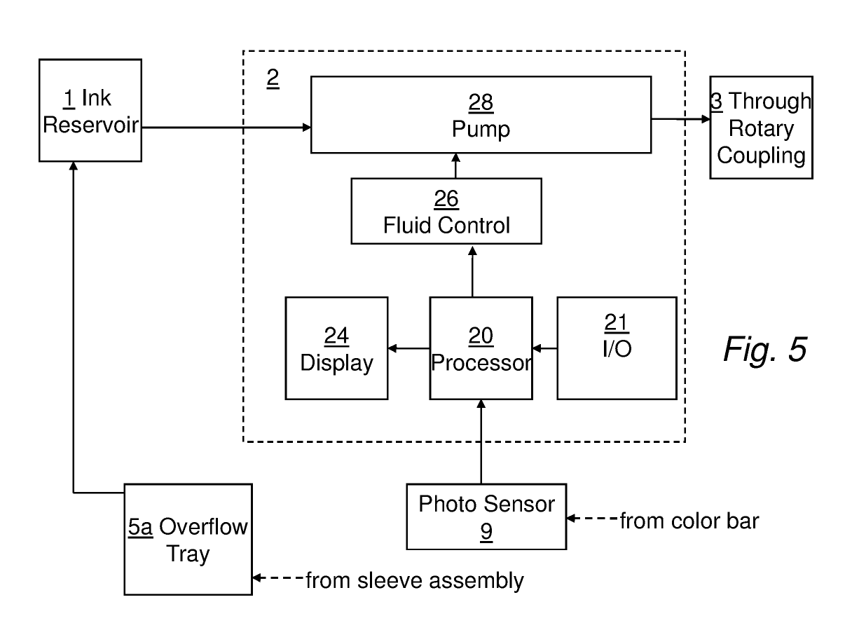

Referring now to FIG. 5 a more detailed example of a pumping and control system as employed in a flexographic printing system in accordance with the disclosure herein is schematically shown. The pumping and control system 2 includes a pump and motor fluid control 26, a pump 28, a processor 20, a display 24, and an input/output system 21. The sensor 9 may advantageously be selected from the group consisting of a photo sensor 9, a spectrodensitometer, a spectrophotometer, a densitometer and a calorimeter. The processor 20 may be connected to the sensor 9 to receive the modified control value. Such sensors are commercially available and are typically used for providing measurements of density, dot gain, trap, print contrast, gray balance, and hue error functions. A densitometer comprises a quality control device to measure the density of printing ink. A calorimeter comprises an instrument for measuring color the way the eye sees color. A spectrodensitometer combines functions of a densitometer with a calorimeter.

For the purposes of this disclosure the processor is understood to encompass a computer processor, a personal computer, a microcontroller, a microprocessor, a field programmable object array (FPOA), a digital signal processor (DSP), an application-specific integrated circuit (ASIC), a field programmable gate array (FPGA), a programmable logic array (PLA), or any other digital processing engine, device or equivalent. The processor may advantageously include a display for monitoring by an operator and an input/output system (e.g. a keyboard and mouse). Other functions may be incorporated into the processor and fluid controls, as for example, ink viscosity controls and mixing systems. In a useful example, an operator may also operate the processor by manually inputting operational modes, control values and the like.

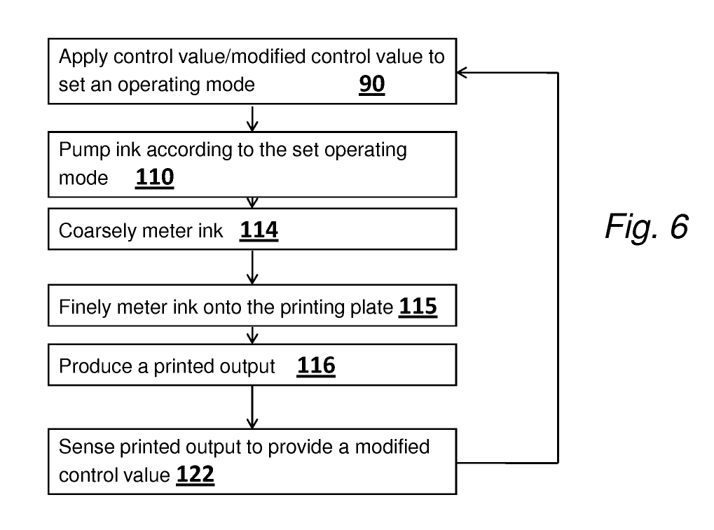

Having described the construction of the contemplated flexographic system, the operation of one example embodiment will now be described to promote further understanding. Referring now to FIG. 6, a flow diagram of a flexographic printing system is schematically shown. Upon initiating the process, a control value is applied 90 to the ink pumping and control system. The ink pumping and control system is responsive to the control value, where the control value sets an operating mode of the ink pumping and control system. Ink is pumped according to the set operating mode 110 through a rotary coupling into a rotating diffusion cylinder including a plurality of passages as described above. Ink is first coarsely metered 114 through the plurality of passages so as to contact the permeable membrane covering the plurality of passages on the diffusion cylinder. Ink passes through the permeable membrane and is finely metered 115 onto the printing plate. The printing plate impresses the printing medium to produce a printed output 116. At least a portion of the printed output is sensed 122 to provide a modified control value, which is, in turn, applied to the ink pumping and control system to vary the pump operation in order to control the amount and consistency of ink being pumped through the downstream components.

In one example embodiment, an operator may read the sensor 9 and manually set the control value on the ink pumping and control system. For other applications requiring continuous feedback and control the sensor 9 may be electronically, digitally or otherwise coupled to transmit the modified control signal to the processor which then automatically applies the modified value to the ink pumping and control system.

For example, the sensor 9 may include a look up table of values with control signals cross-referenced to, for example, a set of densitometer readings. In another example, the control values may be calculated from the sensor readings in a conventional manner within a computer program embedded in the processor. Alternatively the system may be remotely controlled via electromagnetic signals, an Internet Web Site or the like.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

What is claimed is:

1. A method for flexographic printing comprising:
(a) applying a control value to an ink pumping and control system responsive to the control value, where the control value sets an operating mode of the ink pumping and control system;
(b) pumping ink according to the set operating mode through a rotary coupling into a rotating diffusion cylinder, where the diffusion cylinder has an inner channel, an outer surface and a plurality of passages surrounding the inner channel, wherein each of the plurality of passages runs though the diffusion cylinder from the inner channel to the outer surface;
(c) first metering ink through the plurality of passages so as to contact a permeable membrane covering the diffusion cylinder;
(d) secondly metering ink passing through the permeable membrane onto a printing plate or printing sleeve;
(e) impressing the printing plate or printing sleeve onto a printing medium to produce a printed output;
(f) sensing the printed output to provide a modified control value;
(g) applying the modified control value to the ink pumping system; and
(h) repeating steps (b)-(g).

2. The method of claim 1 wherein the diffusion cylinder comprises an elongated cylinder constructed from material selected from the group consisting of metal, aluminum, steel, plastic, polymers and nylon.

3. The method of claim 1 wherein sensing the printed output comprises sensing a portion of the printed output with a sensor selected from the group consisting of a human operator, a photo sensor, a spectrodensitometer, a spectrophotometer, a densitometer and a calorimeter.

4. The method of claim 1 wherein applying the modified control value comprises transmitting the modified control value to a processor.

5. The method of claim 4 wherein the processor includes a display for monitoring by an operator.

6. The method of claim 1 wherein the control value and modified control value are manually set.

7. The method of claim 1 wherein the ink pumping and control system comprises a pump and motor fluid control, a pump, a processor, a display and an input/output system.

8. The method of claim 1 wherein sensing the printed output comprises sensing characteristics of a color bar.

9. A system for flexographic printing comprising:
(a) an ink pumping and control system responsive to a control value, where the control value sets an operating mode of the ink pumping and control system to variably pump ink to a pump output;
(b) an ink reservoir coupled to an input port of the ink pumping and control system;
(c) a rotary coupling coupled at a rotary input to the pump output and further having an output port;
(d) a diffusion cylinder coupled to receive ink pumped through the rotary coupling while rotating, the diffusion cylinder having an inner channel, an outer surface and a plurality of passages surrounding the inner channel, wherein each of the plurality of passages runs though the diffusion cylinder from the inner channel to the outer surface for metering ink at a coarse rate through the plurality of passages;
(e) a permeable membrane sleeve fitted over the diffusion cylinder and covering the plurality of passages to receive the coarsely metered ink and finely meter ink passing through the permeable membrane;
(f) a printing plate or printing sleeve contacting the permeable membrane so as to receive the finely metered ink;
(g) a printing medium in rotary contact with the printing plate or printing sleeve to produce a printed output; and
(h) a sensor disposed to sense a portion of the printed output to provide a modified control value.

10. The system of claim 9 wherein the diffusion cylinder comprises an elongated cylinder constructed from material selected from the group consisting of metal, aluminum, steel, plastic, polymers and nylon.

11. The system of claim 9 wherein the sensor is selected from the group consisting of a human operator, a photo sensor, a spectrodensitometer, a spectrophotometer, a densitometer and a calorimeter.

12. The system of claim 9 wherein a processor is connected to receive the modified control value.

13. The method of claim 12 wherein the processor includes a display for monitoring by an operator.

14. The method of claim 12 wherein the processor includes an input/output system including a human interface.

15. The system of claim 9 wherein the ink pumping and control system comprises a pump and motor fluid control, a pump, a processor, a display and an input/output system.

16. A system for flexographic printing comprising:
(a) means for applying a control value to an ink pumping and control system responsive to the control value, where the control value sets an operating mode of the ink pumping and control system;
(b) means, coupled to the control value applying means, for pumping ink according to the set operating mode through a rotary coupling into a rotating diffusion cylinder, where the diffusion cylinder has an inner channel, an outer surface and a plurality of passages surrounding the inner channel, wherein each of the plurality of passages runs though the diffusion cylinder from the inner channel to the outer surface;
(c) first means, fluidly coupled to the ink pumping means, for metering ink through the plurality of passages so as to contact a permeable membrane covering the diffusion cylinder;
(d) second means, contacting the first means, for metering ink passing through the permeable membrane onto a printing plate or printing sleeve;
(e) means, coupled to receive ink from the second means, for impressing the printing plate or printing sleeve onto a printing medium to produce a printed output;
(f) means for sensing the printed output and located to provide a modified control value to the control value applying means.

17. The system of claim 16 wherein the diffusion cylinder comprises an elongated cylinder constructed from material selected from the group consisting of metal, aluminum, steel, plastic, polymers and nylon.

18. The system of claim 16 wherein the means for sensing the printed output comprises sensing a portion of the printed output with a sensor selected from the group consisting of a human operator, a photo sensor, a spectrodensitometer, a spectrophotometer, a densitometer and a calorimeter.

19. The system of claim 16 wherein the means for applying the control value comprises means for transmitting the modified control value to a processor.

20. The system of claim 16 wherein the means for sensing the printed output comprises means for sensing characteristics of a color bar.
